(19) United States
(12) Patent Application Publication
(10) Pub. No.: US 2004/0265588 A1
(43) Pub. Date: Dec. 30, 2004

(54) Cushion body and foam resin particles for filling cushion body

(76) Inventors: Yoshinobu Ishida, Osaka (JP); Tadaatsu Ueno, Hyogo (JP); Yasuhiro Sakoda, Shiga (JP)

Correspondence Address: GREENBLUM & BERNSTEIN, P.L.C., 1950 ROLAND CLARKE PLACE, RESTON, VA, 20191, US

(21) Appl. No.: 10/490,384

(22) PCT Filed: Oct. 11, 2002
(86) PCT No.: PCT/JP02/10632

(30) Foreign Application Priority Data
Oct. 11, 2001 (JP) 2001-314172

(51) Int. Cl. F16L 1/00

(52) U.S. Cl. 428/402; 428/34.1

(57) ABSTRACT

A cushioning body and expanded resin beads for filling in cushioning body capable of solving such a problem that, when the cushioning bodies such as a bed, a mattress, a pillow, a cushion etc. are used for performing a cushioning function, noise is generated each time the cushioning bodies are moved to provide uncomfortable feeling to users or awake the users while asleep, wherein expanded resin beads with a specified average particle size containing a specified amount of fluidization accelerator are used as the filler for the cushioning body.

### TECHNICAL FIELD

The present invention relates to a cushioning body serving as a cushioning article used suitably as a bed, a mattress, a pillow, a stuffed toy, a cushion, a toy, a cushioning medium, a sealed material, a soundproofing material, a thermal insulating material etc.

### BACKGROUND OF THE INVENTION

As conventional cushioning bodies, those using cotton as fillers are known.

Japanese Unexamined Utility Model Publication No. SHO 56(1981)-115966 describes a cushioning body in a chair form comprising a mixture of expanded resin beads having large to small particle diameters packed as fillers into a bag made of non-stretchable leather (hide). It is described therein that as the expanded resin beads, those having a large particle diameter of about 1 to 5 mm are used.

Japanese Examined Utility Model Publication No. HEI 3(1991)-45641 describes a cushioning body in a matt form comprising expanded resin beads packed as fillers into a bag made of a breathable cloth. It is described therein that as the expanded resin beads, those having a very large particle diameter of 5 to 20 mm are used.

Japanese Patent Publication No. 3057059 describes a cushioning body as a cylindrical sofa having the bottom and side consisting of a non-stretchable material and the top consisting of a stretchable material, wherein a large number of expanded resin beads are packed. It is described therein that as the expanded resin beads, those having a large particle diameter of about 1 to. 2 mm are used.

Among these cushioning bodies, the cushioning bodies using cotton as fillers are those wherein non-flowable cotton is compressed like sponge and deformed while reducing the volume of the cotton, to exhibit cushioning properties. These cushioning bodies are often required to improve the touch and feel, and the cotton easily adsorbs moisture thus permitting mold to grow unless suitably dried.

The cushioning bodies described in Japanese Examined Utility Model Publication No. HEI 3(1991)-45641 and Japanese Unexamined Utility Model Publication No. SHO 56(1981)-115966 supra are common in that expanded resin beads having a large particle diameter of 1 to 20 mm are packed into a non-stretchable bag made of leather or the like. In these publications, the cushioning bodies are obtained by packing the expanded resin beads into a non-stretchable bag. These cushioning bodies are those wherein the packed resin expanded beads having a large particle diameter are merely compressed while reducing the volume of the fillers, to exhibit cushioning properties, and these cushioning bodies, similar to the above-described cushioning bodies using cotton, are inferior in the touch and feel.

This is because in the above cushioning bodies using the expanded resin beads used as fillers, the used expanded resin beads are generally those intended for exclusive use in foam molding. Accordingly, the expanded resin beads hardly move during use, and thus the expanded resin beads having a large particle diameter have been used under the technical idea that cushioning properties are brought by merely deforming the resin beads by mere compression so as to reduce the volume. Accordingly, the publications supra do not describe or suggest expanded resin beads for exclusive use in cushioning bodies.

The cushioning body in Japanese Patent Publication No. 3057059 supra makes use of expanded resin beads having a large particle diameter of about 1 to 2 mm. In view of the constitution of the cushioning body in this publication, it is evident that the expanded resin beads packed so as to reduce the volume by mere compression are based on the technical idea that cushioning properties are brought by deformation upon application of a load.

When a cushioning body using the conventional expanded resin beads is used as a bed, a mattress, a pillow, a stuffed toy, a cushion, a toy etc. for the purpose of exhibiting cushioning properties for the human body, the expanded resin beads hardly move, thus generating an unusual sound upon application of a load and giving an unpleasant feel to cause e.g. a problem of awaking one while asleep, and this problem cannot be solved still yet. Further, there is desire for further improvements in the touch, but cushioning bodies sufficiently meeting this desire are still not provided.

### DISCLOSURE OF INVENTION

The present inventors extensively examined the reason that the expanded resin beads having a large particle diameter of 1 mm or more, intended for exclusive use in foam molding, are inferior in the touch and feel when used as fillers in cushioning bodies. As a result, they found that the conventionally used expanded resin beads are large and hardly slide mutually so that during use, the beads while remaining poor in the touch and feel are merely deformed so as to reduce the volume by compression.

Further, they found that when the large and hardly sliding expanded beads are used, an unusual sound easily occurs.

As a result of extensive study for solving these problems, the present inventors surprisingly found that when expanded resin beads having a specific average particle diameter are made flowable, that is, easily sliding mutually by very small strength, the expanded resin beads can be provided as those for exclusive use in cushioning bodies, with significant improvements in the touch and feel, thus arriving at the~ present invention. These expanded resin beads can be used as fillers in cushioning bodies to prevent occurrence of an unusual sound, to exhibit a preferable touch and to achieve permanent cushioning properties.

According to the present invention, there is provided a first cushioning body comprising a large number of expanded resin beads used as fillers into a bag, wherein the expanded resin beads have an average particle diameter of 400 to 900 μm and a value of 3 Nmm³/g or less obtained by dividing partial compression loading by apparent specific gravity.

According to the present invention, there is also provided a second cushioning body comprising a large number of expanded resin beads used as fillers together with a fluidity accelerator sealed into a bag, wherein the expanded resin beads have an average particle diameter of 400 to 900 μm and the content of the fluidity accelerator is 0.4 to 1.5 parts by weight based on 100 parts by weight of the expanded resin beads.

In the present invention, expanded resin beads having a very small particle diameter in the range of 400 to 900 μm are used as fillers and these beads are made flowable i.e. easily sliding mutually by very small strength thereby achieving significant improvements in the touch and feel as described above. Cushioning bodies using these beads do not generate an unusual sound giving an unpleasant feel.

In the first and second cushioning bodies according to the present invention, use can be made of expanded resin beads each having 25 to 80 bubbles/mm (unit length) in the direction of diameter when cut along a face containing the diameter of the expanded resin particle.

By using the expanded resin beads each having certain bubbles per specific unit length as described above, the beads are made easily flowable to provide a cushioning body preventing occurrence of an unusual sound.

In the first and second cushioning bodies according to the present invention, styrene-based resin having an apparent specific gravity of 0.01 to 0.2 can be used as the expanded resin beads.

By using the styrene-based expanded resin beads having a specified apparent specific gravity as described above, the strength of the expanded resin beads can be maintained, and the weight of the cushioning body can be prevented from being unnecessarily high.

In the first and second cushioning bodies according to the present invention, use can be made of expanded resin beads wherein the amount of residual styrene type monomers is 500 ppm or less or the amount of volatile organic compounds is 1000 ppm or less.

By using the expanded resin beads described above, there can be provided a cushioning body which can be utilized more comfortably even by a very few persons very sensitive to styrene type monomers or volatile organic compounds.

In the first and second cushioning bodies according to the present invention, the bag is constituted preferably of a stretchable material.

The bag described above can be used to exhibit the following effects. First, the expanded resin beads have the effect described above, that is, the expanded resin beads have easily fluidizing and sliding properties upon application of very small strength, thus providing the cushioning body with significant improvement in the touch and feel. A stretching material is uses for the bag so that when a part of the cushioning body is compressed, the packed beads can move from the compressed region to the rest of the bag, whereupon the rest of the bag can be stretched and deformed to accommodate the moving beads, thus broadening the allowable range of movement of the beads. In addition, the cushioning body having a better feel can be provided due to the synergistic effect of the expanded resin beads and the bag.

For example, when the surface of the bag is printed with a face having eyes, nose, and mouth etc., the face can give expressions by the properties of the expanded resin beads and the bag (called an animation effect).

Further, in the case of the cushioning body ridden or hold by a person, the above synergistic effect gives suitable stimuli to the skin of the person, which would generate much alpha wave in the brain. As a result, the bag can be expected to provide a cushioning body making the person more easily relaxing.

In the first and second cushioning bodies according to the present invention, a bag provided with a double fastener capable of opening and closing can be used.

Such bag when used can effectively prevent leakage of the fillers therefrom.

According to the present invention, there are also provided expanded resin beads filling in the first cushioning body, which have an average particle diameter of 400 to 900 μm and a value of 3 Nmm³/g or less obtained by dividing partial compression loading by apparent specific gravity.

According to the present invention, there are further provided expanded resin beads filling in the second cushioning body, which comprise a large number of expanded resin beads having an average particle diameter of 400 to 900 μm and a fluidity accelerator, wherein the content of the fluidity accelerator is 0.4 to 1.5 parts by weight based on 100 parts by weight of the expanded resin beads

By using the expanded resin beads filling in the first and second cushioning bodies described above, the first and second cushioning bodies having the excellent characteristics described above can be provided.

### BRIEF DESCRIPTION OF THE DRAWINGS

FIG. 1 is an electron microscope photograph of section of the formed resin particle of Example 6.

### MODE FOR CARRYING OUT THE INVENTION

The first and second cushioning bodies of the present invention comprise a bag and fillers sealed therein. The fillers comprise expanded resin beads filling in the first and second cushioning bodies.

As the expanded resin beads constituting the expanded resin beads filling in the first and second cushioning bodies according to the present invention, use can be made of expanded resin beads made of styrene-based resin, polyethylene-based resin, polypropylene-based resin etc. The average particle diameter of the expanded resin beads is 400 to 900 μm, among which expanded resin beads having an average particle diameter of 500 to 850 μm are preferably used to prevent occurrence of an unusual sound and to give a more preferable feel. Further, the expanded resin beads are more preferably those having the above average particle diameter and substantially free of beads having a particle diameter greater than 2 mm in order to exhibit particularly outstanding effects for prevention of an unusual sound and for a more preferable feel. The method of measuring the average particle diameter is described in the Examples.

In the expanded resin beads filling in the first cushioning body, the expanded resin beads have a value of 3 Nmm³/g or less obtained by dividing partial compression loading by apparent specific gravity. When this value is greater than 3 Nmm³/g, their effect on prevention of generation of an unusual sound is insufficient. The value obtained by dividing partial compression loading by apparent specific gravity is more preferably 1 to 3 Nmm³/g. The methods of measuring the partial compression loading and apparent specific density are described in the Examples.

In the expanded resin beads filling in the second cushioning body, the content of the fluidity accelerator (fluidizing agent) is 0.4 to 1.5 parts by weight based on 100 parts by weight of the expanded resin beads. This fluidity accelerator functions as a lubricant for the expanded resin beads, and can act in preventing occurrence of an unusual sound attributable to the expanded resin beads rubbing mutually upon fluidization. The content of the fluidity accelerator in the present specification means the amount of the fluidity accelerator actually contained in the fillers, but not the amount thereof as the starting material added to the resin beads.

The fluidity accelerator includes, for example, salts of fatty acids (stearic acid, lauric acid, palmitic acid) and metals (magnesium, calcium, zinc, barium, aluminum), and calcium carbonate, polyethylene wax etc. Among these, zinc stearate, calcium stearate, and magnesium stearate are particularly preferable. If the content of the fluidity accelerator is less than 0.4 part by weight, the fluidity may be insufficient and its effect on prevention of occurrence of an unusual sound tends to be insufficient, while even if the fluidity accelerator is contained in an amount of higher than 1.5 parts by weight, no further effect can be expected. The fluidity accelerator is contained more preferably in an amount of 0.45 to 1.2 parts by weight. The method of measuring the content of the fluidity accelerator is described in the Examples.

The expanded resin beads filling in the cushioning body according to the present invention preferably have the constitutions of the expanded resin beads for both the first and second cushioning bodies. That is, the expanded resin beads filling in the cushioning body are those comprising expanded resin beads having an average particle diameter of 400 to 900 μm and a value of 3 Nmm³/g or less obtained by dividing partial compression loading by apparent specific gravity, and a fluidity accelerator, wherein the content of the fluidity accelerator is 0.4 to 1.5 parts by weight based on 100 parts by weight of the expanded resin beads.

The expanded resin beads filling in the first and second cushioning bodies preferably have an apparent specific density of 0.01 to 0.2. An apparent specific density of greater than 0.2 is not preferable because the weight of the resulting cushioning body is increased, while an apparent specific density of less than 0.01 is not preferable either because the strength of the expanded resin beads filling in the cushioning bodies is decreased. The apparent specific density is more preferably 0.015 to 0.05.

In the expanded resin beads filling in the first and second cushioning bodies, the shape of bubbles constituting the beads, the diameter of the bubbles, the number of the bubbles, etc. are not particularly limited insofar as the effect of the present invention is not deteriorated. In particular, the present inventors found that the expanded resin beads each having 25 to 80 bubbles/mm (unit length) in the direction of diameter when cut along a face containing the diameter thereof lead to further improvements in the performance of the cushioning body. Less than 25 bubbles/mm are not preferable because the fluidity of the beads is easily deteriorated and an unusual sound easily occurs, while 80 or more bubbles/mm are not preferable either because the thickness of a bubble membrane-maintaining a bubble is too thin, thus reducing the strength of the expanded resin beads. The method of measuring the number of bubbles is described in the Examples.

The expanded resin beads filling in the first and second cushioning bodies are made preferably of styrene-based resin to achieve a more preferable feel. As the styrene-based resin, styrene-based resin beads wherein the amount of residual styrene type monomers is 500 ppm or less are preferably used. By expanding these resin beads, expanded resin beads wherein the amount of residual styrene type monomers is 500 ppm or less can be obtained, and as a result, the content of these compounds considered contributable to a sick-house syndrome in recent years and hypersensitivity to chemicals can be significantly reduced, thus providing a suitable cushioning body for a very small number of people sensitive to these substances. From these viewpoints, the residual styrene type monomers are preferably as low as possible, and specifically the content of these monomers is more preferably 300 ppm or less, still more preferably 150 ppm or less, further still more preferably nearly 0.

These expanded resin beads can be produced for example by incorporating an expanding agent into styrene-based resin beads and then expanding the beads by utilizing steam heat etc. Among the expanded styrene-based resin, the expanded resin beads wherein the content of volatile organic compounds is limited to 1000 ppm or less are most preferable as fillers in the cushioning body. The expanded resin beads wherein the content of volatile organic compounds is 1000 ppm or less can be produced by using any expanding agents described below, particularly expanding agents based on CO₂ gas, nitrogen and air. The content of volatile organic compounds is preferably as low as possible, more preferably nearly 0, from the viewpoint of preventing the sick-house syndrome.

Examples of the volatile organic compounds in the expanded resin beads include not only residual styrene type monomers but also aromatic hydrocarbons such as toluene, ethylbenzene, cumene and propylbenzene and aliphatic hydrocarbons such as butane and pentane. Specifically, the volatile organic compounds include organic compounds based on hydrocarbons appearing in a shorter time than that of n-hexadecane containing 16 carbon atoms (boiling point at normal pressures: 286° C.) in a chromatograph obtained in measurement by gas chromatography, the hydrocarbons including aromatic hydrocarbons such as toluene and styrene, aliphatic hydrocarbons such as butane and pentane and alicyclic hydrocarbons such as cyclopentane and cyclohexane.

To reduce the amount of residual styrene type monomers in the expanded resin beads, it is preferable that a polymerization initiator of high-temperature initiation type, for example, is used in suspension polymerization in an amount of at least 0.05% by weight based on styrene monomers and the final polymerization temperature is 115° C. or more.

The polymerization initiator of high-temperature initiation type is particularly preferably the one giving a half-life of 10 hours at a temperature of 100 to 115° C., such as t-butyl peroxybenzoate, t-butyl peroxypivalate, t-butyl peroxyisopropyl carbonate, t-butyl peroxyacetate and 2,2-t-butyl peroxybutane.

The expanding agent used in preparing the expanded resin beads includes physical expanding agents, for example, aliphatic hydrocarbons such as propane, n-butane, iso-butane, n-pentane, iso-pentane, neopentane, hexane etc.; alicyclic hydrocarbons such as cyclobutane, cyclopentane etc.; halogenated hydrocarbons such as methyl chloride and dichlorofluoromethane; and inorganic gases such as CO₂ gas, nitrogen, air etc. These expanding agents can be used alone, or two or more thereof can be simultaneously used, and particularly those expanding agents comprising CO₂ gas, nitrogen, air or the like as a major component are used preferably in order to obtain the formed resin beads wherein the content of volatile organic compounds is 1000 ppm or less. The amount of the expanding agent is preferably about 1 to 20 parts by weight based on 100 parts by weight of the resin beads. When CO₂ gas etc. are used as the expanding agent, the pressure for impregnation with the expanding agent is 10 to 30 kg/cm²G, and the impregnation time is preferably about 1 to 10 hours.

To obtain the expanded resin beads filling in the first and second cushioning bodies, a nucleating agent may be added during polymerization and/or impregnation. By adding the nucleating agent, the number of bubbles can be regulated. The amount of the nucleating agent added is regulated suitably to attain the desired number of bubbles, and usually its amount is 0.005 to 1 part by weight based on 100 parts by weight of the resin beads. The number of bubbles can also be regulated by selecting the type and amount of the expanding agent.

When the expanded resin beads filling in the first and second cushioning bodies are made of styrene-based resin beads, the styrene type monomers usable in the resin beads include styrene, α-methylstyrene, o-methylstyrene, m-methylstyrene, p-methylstyrene, vinyltoluene, p-ethylstyrene, 2,4-dimethylstyrene, p-methoxystyrene, p-phenylstyrene, o-chlorostyrene, m-chlorostyrene, p-chlorostyrene, 2,4-dichlorostyrene, p-n-butylstyrene, p-t-butylstyrene, p-n-hexylstyrene, p-octylstyrene, styrenesulfonic acid and sodium styrenesulfonate.

Further, it is also possible to simultaneously use various vinyl compounds, for example C₁₋₁₀ alkyl acrylates such as methyl acrylate, ethyl acrylate, propyl acrylate, butyl acrylate and 2-ethylhexyl acrylate; C₁₋₁₀ alkyl methacrylates such as methyl methacrylate, ethyl. methacrylate, propyl methacrylate, butyl methacrylate and 2-ethylhexyl methacrylate; unsaturated compounds having a hydroxyl group, such as hydroxyethyl acrylate, hydroxyethyl methacrylate, hydroxypropyl acrylate, hydroxypropyl methacrylate, hydroxybutyl acrylate and hydroxybutyl methacrylate; unsaturated compounds containing a nitrile group, such as acrylonitrile and methacrylonitrile; organic acid vinyl compounds such as vinyl acetate and vinyl propionate; unsaturated monoolefins such as ethylene, propylene, 1-butene, 2-butene and isobutene; diene compounds such as butadiene, isoprene and chloroprene; vinyl halides such as vinyl chloride, vinylidene chloride, vinyl bromide and vinyl fluoride; vinyl ketones such as vinyl methyl ketone, vinyl ethyl ketone and vinyl hexyl ketone; vinyl ethers such as vinyl methyl ether, vinyl ethyl ether and vinyl isobutyl ether; N-vinyl compounds such as N-vinyl pyrrolidone, N-vinyl indole, N-vinyl carbazole and N-vinyl pyrrole; unsaturated compounds having an amide group, such as acrylamide, methacrylamide, N-methylol acrylamide and N-methylol methacrylamide; unsaturated carboxylic acids such as acrylic acid, methacrylic acid and itaconic acid; maleimide compounds such as N-phenyl maleimide, N-(methyl)-phenyl maleimide, N-(hydroxy)phenyl maleimide, N-(methoxy) phenyl maleimide, N-benzoic acid maleimide, N-methyl maleimide, N-ethyl maleimide, N-n-propyl maleimide, N-isopropyl maleimide, N-n-butyl maleimide, N-isobutyl maleimide and N-t-butyl maleimide; crosslinking multifunctional vinyl compounds such as divinyl benzene and ethylene glycol dimethacrylate; and unsaturated compounds having an epoxy group, such as glycidyl acrylate and glycidyl methacrylate.

The resin beads having an average particle diameter of about 0.2 to 0.955 mm can be obtained by suspension polymerizing from the styrene type monomers described above using water-soluble polymers such as polyvinyl alcohol, methyl cellulose, polyvinyl pyrrolidone etc. and sparingly soluble inorganic'salts such as magnesium pyrophosphate, calcium tertiary phosphate etc. The monomers may be added in one portion or little by little to the aqueous medium.

If necessary, additives such as a flame retardant, a flame retardant assistant, a particle size distribution regulator etc. may be suitably added, or rubber components such as butadiene rubber, styrene-butadiene rubber etc. can be mixed. Further, polyoxyethylene alkylphenol ether, stearic acid monoglyceride etc. may also be used as antistatic agents. Together with these other agents, a small amount of a spreading agent consisting of polybutene, ethylene glycol or silicone oil may be added.

Further, the styrene-based expanded resin beads are produced by expanding the thus obtained styrene-based expandable resin beads by steam heating etc. As the expanding method, a method of expanding the beads for example by steam heating etc. with a cylindrical preliminary expanding machine can be used. An expansion ratio of the styrene-based expanded resin beads are preferably at about 5- to 100-fold (apparent specific density 0.01 to 0.2). In particular, the beads expanded at about 20- to 65-fold (apparent specific density 0.015 to 0.05) can give a particularly excellent feel.

The method of incorporating a fluidity accelerator into the expanded resin beads to be filling in the second cushioning body includes, for example, a method of incorporating it into monomers for forming the expanded resin beads, a method of incorporating it into the resin beads before impregnation with an expanding agent and after completion of polymerization, a method of incorporating it into the expandable resin beads impregnated with an expanding agent and a method of incorporating it into the expanded resin beads after expanding. In particular, the method of incorporating it into the expandable resin beads is preferable from the viewpoint of easy production of the expanded resin beads.

The fluidity accelerator may be incorporated in any forms such as powder, membrane etc. into the expanded resin beads.

When the fluidity accelerator is powder, its average particle diameter is preferably smaller than the average particle diameter of at least the expanded resin beads, and is specifically in the range of 0.1 to 100 μm, more preferably in the range of 0.1 to 30 μm. From another viewpoint, the average particle diameter of the fluidity accelerator is preferably in the range of about 1/1000 to 1/10 based on the average particle diameter of the expanded resin beads. The shape of the powder may be spherical, acicular, scaly, bulky, amorphous etc. Further, polybutene, polyethylene glycol, silicone oil etc. may be added as the spreading agent to the fluidity accelerator added. The amount of the spreading agent added is preferably 1 to 20 parts by weight based on 100 parts by weight of the fluidity accelerator added.

When the spreading agent is not used, the expanded resin beads are stirred preferably under conditions regulated suitably such that a predetermined amount of the fluidity accelerator is contained therein. For example, the beads are stirred preferably under relatively high shear force by using a stirring machine such as a Henschel mixer. When the spreading agent is used, the spreading agent facilitates incorporation of the fluidity accelerator into the expanded resin beads, and thus the fluidity accelerator can be incorporated into the expanded resin beads by stirring under more moderate conditions than when the spreading agent is not used.

In the case of membrane, the membrane can be formed for example by a method of dissolving the fluidity accelerator in a solvent, spraying the resulting solution onto the resin beads and drying it or by a method of dipping the resin beads in the solution and then drying it. Further, when the fluidity accelerator is melted at a relatively low temperature, the membrane can also be formed by coating the resin beads with or dipping them in the melted fluidity accelerator.

The bag usable in the first and second cushioning bodies in the present invention can make use of a cloth made of a stretchable material, chemical fibers, silk, cotton etc. In particular, the bag is made preferably of the stretchable material in order to confer an excellent feel. The stretchable material is for example an elastic material, most preferably spandex (elastic fibers of polyurethane).

By using the bag described above, the following effects are demonstrated. First, the expanded resin beads have the effect described above, that is, the expanded resin beads have easily fluidizing and sliding properties upon application of very small strength, thus providing the cushioning body with significant improvement in the touch and feel. A stretching material is uses for the bag so that when a part of the cushioning body is compressed, the packed beads can move from the compressed region to the rest of the bag, whereupon the rest of the bag can be stretched and deformed to accommodate the moving beads, thus broadening the allowable range of movement of the beads. In addition, the cushioning body having a better feel can be provided due to the synergistic effect of the expanded resin beads and the bag.

The above-described expanded resin beads to be packed in the first and second cushioning bodies are used as fillers for preventing generation of an unusual sound, for exhibiting a preferable feel and for satisfying permanent cushioning properties, and in a more preferable mode, the cushioning bodies are provided with a double fastener capable of opening and closing, thus preventing these fillers from leaking out from the bag. Further, the bag constituted to be a double bag is effective.

Also, the bag can be constituted by introducing a plurality of bags charged with the fillers into one large bag. In this case, the fillers in a plurality of bags may use those different in the feel from one another.

There can be provided a cushioning body serving as a cushioning article used preferably as a bed, a mattress, a pillow, a stuffed toy, a cushion, a toy, a cushioning medium, a sealed material, a soundproofing material, a thermal insulating material etc.

When the cushioning body is used as a cushioning body ridden or hold by a person, the above synergistic effect gives suitable stimuli to the skin of the person, which would generate much alpha wave in the brain. As a result, it can be expected to provide a cushioning body making the person more easily relaxing.

Further, the bag may be printed with e.g. a face having eyes, nose, and mouth etc. In this case, the face can give expressions by the properties of the expanded resin beads and the bag (called an animation effect).

### EXAMPLES

Hereinafter, the present invention is described in more detail by the Examples and Comparative Examples, which however are not intended to limit the present invention. The evaluation methods are described below.

<Method of Measuring the Average Particle Diameter>

In the Examples, the average particle diameter is a value expressed in terms of D50. Specifically, the beads are classified by JIS standard screens having a screen opening of 4.00 mm, an opening of 3.35 mm, an opening of 2.80 mm, an opening of 2.36 mm, an opening of 2.00 mm, an opening of 1.70 mm, an opening of 1.40 mm, an opening of 1.18 mm, an opening of 1.00 mm, an opening of 0.85 mm, an opening of 0.71 mm, an opening of 0.60 mm, an opening of 0.50 mm, an opening of 0.425 mm, an opening of 0.355 mm, an opening of 0.300 mm, an opening of 0.250 mm, an opening of 0.212 mm and an opening of 0.180 mm, respectively, and from these results, a cumulative weight distribution curve is prepared, and the particle diameter (median diameter) at which the cumulative weight is 50% on the curve is referred to as the average particle diameter in the Examples.

<Method of Measuring the Content of the Fluidity Accelerator>

1.0 g of expanded resin beads are accurately weighed, then placed in a crucible, and converted into ash by heating at 450° C. for 3 hours. Then, 2 ml of conc. hydrochloric acid is added to the ash and adjusted to 25 ml with distilled water. Thereafter, the sample is measured for the amount of each metal by ICP-AES, and the amount of each fatty metal salt is calculated using its molecular weight and expressed as the amount of the fluidity accelerator relative to 100 parts by weight of the expanded resin beads. The conditions for measurement by ICP-AES and the formulae for calculation of the amount of aliphatic metal salt are shown below:

(Measurement conditions)

Unit: SEIKO ICP SPS-4000

Measurement wavelengths: Zn (213.856 nm), Mg (285.213 nm),

Ca (317.933 nm)

Photometric height: 10.0 mm

Integrating condition: 3 times—1 second (integrated once)

High-frequency output: 1.30 kw

Gas flow rate: Plasma gas flow rate, 16.0 L/min.

Carrier gas flow rate, 1.0 L/min.

Auxiliary gas flow rate, 0.5 L/min.

(Formulae for calculation of the amount of fatty metal salt)

Zinc stearate=amount of Zn×(631.4/65.4)

Magnesium stearate=amount of Mg×(590.3/24.3)

Calcium stearate=amount of Ca×(606.1/40.1)

<Method of Measuring the Partial Compression Loading>

A glass beaker (volume, 200 ml; body diameter, 67 mm; height, 89 mm) manufactured by Masuda Rika Kogyo Co., Ltd. is charged with 200 ml of expanded resin beads. Then, the loading required for an SUS cylinder of 35 mm in diameter to be pushed by 10 mm at a rate of 20 mm/min. into the expanded resin beads is determined by Tensilon Universal Testing Machine UCT-10T (manufactured by ORIENTEC CORPORATION), and the value thus determined is referred to as partial compression loading.

<Method of Measuring the Apparent Specific Density>

An apparent specific density-measuring cup (internal volume, 100 ml) in a powder tester (manufactured by Hosokawa Micron Co., Ltd.) is charged gently with the expanded resin beads, and the surface of the expanded resin beads is cut flat on the cup by means of its equipped blade standing vertically, and the weight is measured with a pan balance and then divided by 100. The value thus obtained is referred to as apparent specific density.

<Method of Measuring the Number of Bubbles>

A expanded resin particle is cut in about half by a knife, and a microphotograph of its section is taken, and line 1 is drawn on the section in the direction of diameter of the particle, and the number of bubbles on which line 1 was drawn is counted to determine the number of bubbles/mm. Then, line 2 is drawn on the section in the direction perpendicular to line 1, and the number of bubbles is measured in the same manner as above to determine the number of bubbles/mm. The two numbers of bubbles/mm thus determined are averaged and one decimal place is rounded off. Five beads are examined by this method, and the numbers of bubbles/mm thud determined, excluding the maximum and minimum, are averaged and rounded off. The value thus obtained is referred to as the number of bubbles.

<An Unusual-Sound Test>

A double bag (size 20 cm×20cm) with a double faster, made of a stretchable material spandex (Beruna 6994 manufactured by Kanebo Gosensha) is charged with 2 L of expanded resin beads, and whether an unusual sound occur or not upon compression of the bag by a cylinder of 10 cm in diameter at a rate of 2 cm/second is evaluated. X is given when an unusual sound is generated, while ◯ is given when no sound is generated.

<Feel Test>

A double bag (size 20 cm×20 cm) with a double faster, made of a stretchable material spandex (Beruna 6994 manufactured by Kanebo Gosensha) is charged with 2 L of expanded resin beads, and its feel is evaluated 10 examiners. ⊚ is given when 8 or more examiners judged the bag to have a good feel, ◯ is given when 6 or 7 examiners judged so, and X is given when 5 or less examiners judged so and a cushioning body judged to have a good feel by 6 or more examiners is regarded as an acceptable product.

<Method of Measuring the Amount of Residual Styrene Type Monomers>

The expanded resin beads are dissolved in dimethylformamide, and the solution with an internal standard solution (cyclopentanol) added thereto is measured by GC. A peak of the styrene type monomers is specified by using a standard sample prepared by mixing styrene with the internal standard solution in a specific ratio.

GC: GC-14A manufactured by Shimadzu Corporation

Column: PEG-20M PT 25% 60/80 (2.5 m)

Column temperature: 105° C.

Detector (FID) temperature: 220° C.

<Content of Volatile Organic Compounds>

The content is determined by totaling up values obtained by the following 3 methods.

(Measurement of Hydrocarbon Compounds Containing 5 or Less Carbon atoms)

The expanded resin beads are placed in a pyrolysis oven of 150° C., and volatilized hydrocarbons are measured by gas chromatography.

Gas chromatography (GC): GC-14B manufactured by

Shimadzu Corporation

Pyrolysis oven: PYR-LA manufactured by Shimadzu Corporation

Column: Polapak Q 80/100 (3 mmφ×1.5 mm)

Column temperature: 100° C.

Detector (FID) temperature: 120° C.

(Measurement of hydrocarbons ranging from hydrocarbons containing 6 or more carbon atoms to hydrocarbons until a peak of styrene appearing in a gas chromatogram)

The expanded resin beads are dissolved in dimethylformamide, and the solution with an internal standard solution (cyclopentanol) added thereto is measured by GC. A peak which cannot be specified is quantified in terms of the amount of toluene detected.

GC: GC-14A manufactured by Shimadzu Corporation

Column: PEG-20M PT 25% 60/80 (2.5 m)

Column temperature: 105° C.

Detector (FID) temperature: 220° C.

(Measurement of hydrocarbons ranging from a hydrocarbon next to a peak of styrene to a C 16 hydrocarbon (n-hexadecane) appearing in a gas chromatogram)

The expanded resin beads are dissolved in chloroform and measured by gas chromatography mass spectrometer (GCMS). From the content thus determined, the mass detected in a blank test separately conducted using the solvent not containing the test sample is subtracted. A peak which cannot be specified is quantified in terms of the amount of toluene detected.

GCMS: QP5000 manufactured by Shimadzu Corporation

Column: DB-1 manufactured by J&W Scientific Co., Ltd.

(1 μm×60 m, 0.25 mmφ)

Measurement condition: column temperature (kept at 60° C. for 1 minute and then raised to 300° C. at a rate of 10° C./min.)

Split ratio: 10

Carrier gas: He (1 ml/min)

Interface temperature: 260° C.

### Example 1

120 g of tricalcium phosphate (trade name: calcium tertiary phosphate, manufactured by Taihei Kagak Co., Ltd.), 0.24 g of sodium hydrogen sulfite and 0.24 g of potassium persulfate were introduced into a 100-L autoclave, and 133 g of benzoyl peroxide (purity 75%, trade name: Niper BW, manufactured by Nippon Oil and Fats Co., Ltd.), 28 g of t-hexylperoxy isopropyl monocarbonate (purity 90%, trade name: Perhexyl I, manufactured by Nippon Oil and Fats Co., Ltd.), 40 kg of deionized water and 40 kg of styrene monomer were further introduced into the mixture, dissolved and suspended under stirring to prepare a suspension.

Then, the styrene monomer was subjected under stirring at 200 rpm to polymerization reaction at 87° C. for 8 hours and then at 125° C. for 2.5 hours. After the reaction was finished, the reaction mixture was cooled, removed from the autoclave, centrifuged and dried to give styrene resin beads. The resulting styrene resin beads were sifted into 0.25 to 0.355 mm beads.

Separately, 2000 g of water, 12 g of magnesium pyrophosphate, 0.3 g of sodium dodecylbenzenesulfonate, 0.4 g of dilauryl-3,3′-thiodipropionate and 0 6 g of ethylene bis-stearic acid. amide were introduced into a 5-L autoclave to prepare an aqueous medium. 2000 g of the above sifted 0.25 to 0.355 mm styrene resin beads were added to this aqueous medium and stirred at 300 rpm.

Then, the temperature of the aqueous medium was raised to 110° C., and while this temperature was maintained, 180 g of pentane was injected into the autoclave, and the resin beads were impregnated with the pentane for 1.5 hours and cooled to give expandable styrene resin beads.

850 g of the expandable styrene resin beads were coated with 5.95 g of zinc stearate (flaky form; fluidity accelerator, 0.7 part by weight, average particle diameter of about 15 μm) and 0.17 g of polyethylene glycol (spreading agent) by mixing at high speed with a Henschel mixer, and then uniformly heated with water vapor with a batch preliminary expanding machine having an internal volume of 50 L, to give expanded resin beads. The resulting expanded resin beads were dried in a drying chamber at 30° C. for 1 day. The resulting expanded resin beads were measured for their average particle diameter, fluidity accelerator content, partial compression loading, apparent specific gravity, number of bubbles and residual styrene monomer, and examined in an unusual-sound test and a feel test. The expanded resin beads did not contain beads of greater than 2 mm in diameter. The results are shown in Table 1.

### Example 2

Expanded resin beads were obtained in the same manner as in Example L except that the amount of zinc stearate added was 8.50 g (1.0 part by weight). The resulting expanded resin beads were measured for their average particle diameter, fluidity accelerator content, partial compression loading, apparent specific gravity, number of bubbles and residual styrene monomer, and examined in an unusual-sound test and a feel test. The expanded resin beads did not contain beads of greater than 2 mm in diameter. The results are shown in Table 1.

### Example 3

Expanded resin; beads were obtained in the same manner as in Example 1 except that the amount of zinc stearate added was 15.3 g (1.8 parts by weight). The resulting expanded resin beads were measured for their average particle diameter, fluidity accelerator content, partial compression loading, apparent specific gravity, number of bubbles and residual styrene monomer, and examined in an unusual-sound test and a feel test. The expanded resin beads did not contain beads of greater than 2 mm in diameter. The results are shown in Table 1.

### Comparative Example 1

Expanded resin beads were obtained in the same manner as in Example 1 except that the amount of zinc stearate added was 3.40 g (0.4 part by weight). The resulting expanded resin beads were measured for their average particle diameter, fluidity accelerator content, partial compression loading, apparent specific gravity and number of bubbles, and examined in an unusual-sound test and a feel test. The expanded resin beads did not contain beads of greater than 2 mm in diameter. The results are shown in Table 1.

### Example 4

Expanded resin beads were obtained in the same manner as in Example 1 except that magnesium stearate (average particle diameter of about 18 μm; flaky form) was used in place of zinc stearate. The resulting expanded resin beads were measured for their average particle diameter, fluidity accelerator content, partial compression loading, apparent specific gravity, number of bubbles and residual styrene monomer, and examined in an unusual-sound test and a feel test. The expanded resin beads did not contain beads of greater than 2 mm in diameter. The results are shown in Table 1.

### Example 5

Expanded resin beads were obtained in the same manner as in Example 1 except that calcium carbonate (average particle diameter of about 28 μm; bulky form) was used in place of zinc stearate. The resulting expanded resin beads were measured for their average particle diameter, fluidity accelerator content, partial compression loading, apparent specific gravity, number of bubbles and residual styrene monomer, and examined in an unusual-sound test and a feel test. The expanded resin beads did not contain beads of greater than 2 mm in diameter. The results are shown in Table 1.

### Example 6

Expanded resin beads were obtained in the same manner as in Example 1 except that 0.6 g of dilauryl-3,3′-thiodipropionate was used, and the amount of zinc stearate added was 4.25 g. (0.50 part by weight). The resulting expanded resin beads were measured for their average particle diameter, fluidity accelerator content, partial compression loading, apparent specific gravity and residual styrene monomer, and examined in an unusual-sound test and a feel test. The expanded resin beads did not contain beads of greater than 2 mm in diameter. The results are shown in Table 1.

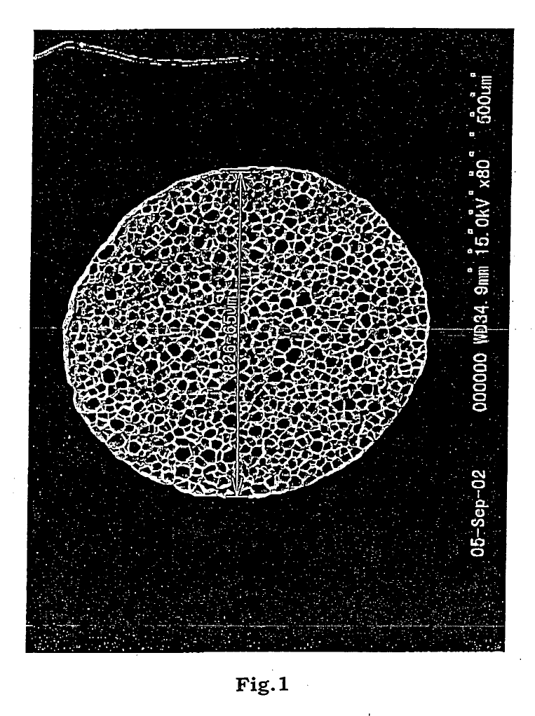

A photograph of a section of the expanded resin particle is shown in FIG. 1. The method of measuring the number of bubbles by using this photograph is described. For example, in FIG. 1, the number of bubbles on line 1 (length 826.65 μm) is 38 (46.0 bubbles/mm). The number of bubbles on line 2 (length 900.00 μm) perpendicular to line 1 and passing through the center of line 1 is 44 (48.8 bubbles/mm). Accordingly, the number of bubbles in this particle is 47 bubbles/mm. The numbers of bubbles in arbitrary 4 beads, which were determined in the same manner, were 46 bubbles/mm, 47 bubbles/mm, 47 bubbles/mm and 46 bubbles/mm, respectively, and the number of bubbles/mm in the beads in Example 6 was 47 bubbles/mm.

### Example 7

Expanded resin beads were obtained in the same manner as in Example 1 except that 1.0 g of dilauryl-3,3′-thiodipropionate was used, and the amount of zinc stearate added was 8.50 g (1.0 part by weight). The resulting expanded resin beads were measured for their average particle diameter, fluidity accelerator content, partial compression loading, apparent specific gravity, number of bubbles and residual styrene monomer, and examined in an unusual sound test and a feel test. The expanded resin beads did not contain beads of greater than 2 mm in diameter. The results are shown in Table 1.

### Comparative Example 2

Expanded resin beads were obtained in the same manner as in Example 1 except that sifted 0.5 to 0.71 mm styrene resin beads were used. The resulting expanded resin beads were measured for their average particle diameter, fluidity accelerator content, partial compression loading, apparent specific gravity, number of bubbles and residual styrene monomer, and examined in an unusual-sound test and a feel test. The expanded resin beads contained about 18% by weight of beads greater than 2 mm in diameter. The results are shown in Table 1.

### Example 8

Expanded resin beads were obtained in the same manner as in Example 1 except that 730 g of expandable styrene resin beads were used, and the amount of zinc stearate added was 5.11 g (0.7 part by weight). The resulting expanded resin beads were measured for their average particle diameter, fluidity accelerator content, partial compression loading, apparent specific gravity, number of bubbles and residual styrene monomer, and examined in an unusual-sound test and a feel test. The expanded resin beads did not contain beads of greater than 2 mm in diameter. The results are shown in Table 1.

### Example 9

40 kg of purified water, 2.2 g of sodium dodecylbenzenesulfonate and 60 g of magnesium pyrophosphate were introduced into a reactor with an internal volume of 100 L, to prepare an aqueous medium. Then, 44 kg of styrene in which 165 g of benzoyl peroxide (purity 75%), 33 g of t-butylperoxy benzoate and 22 g of polyethylene wax (molecular weight 1000) had been dissolved was added thereto under stirring and suspended, and then the mixture was heated to 90° C. to initiate polymerization. When the polymerization proceeded until the degree of polymerization conversion as determined by a specific density method reached 95% by weight, the reactor was heated to 126° C., kept at the temperature for 2 hours and then cooled to ordinary temperature, and the reaction mixture was removed to give styrene resin beads [A]. The residual styrene in the resulting styrene resin beads, as determined by gas chromatography, was 283 ppm.

15 kg of beads having an average particle diameter of 0.25 to 0.3 mm, out of the styrene resin beads [A], were introduced into a rotary pressure-resistant container with an internal volume of 30 L, and 5 g of polyethylene glycol 300 as a spreading agent and 105 g (0.7 part by weight) of magnesium stearate and 5 g (0.03 part by weight) of calcium carbonate as fluidity accelerators were added thereto, and the container was rotated to permit these materials to adhere to the surfaces of the resin beads. After rotation was terminated, CO₂ gas was injected into the container, and the resin beads were impregnated with CO₂ gas at 25° C. at 30 kg/cm²G for 6 hours, to give expandable styrene resin beads.

The expandable styrene resin beads thus obtained were removed from the pressure-resistant container and immediately introduced into an expanding machine equipped with a stirrer, followed by introducing water vapor at a water vapor pressure of 1.2 kg/cm²G into the expanding machine, to give expanded resin beads. The expanded resin beads contained 121 ppm styrene monomer, and the amount of total volatile organic compounds excluding the styrene monomer, determined by the 3 measurement methods described above, was 562 ppm. Accordingly, the content of volatile organic compounds in the expanded resin beads was 683 ppm.

The resulting expanded resin beads were measured for their average particle diameter, fluidity accelerator content, partial compression loading, apparent specific gravity, number of bubbles and residual styrene monomer, and examined in an unusual-sound test and a feel test. The expanded resin beads did not contain beads of greater than 2 mm in diameter. The results are shown in Table 1. The content of the fluidity accelerator in this example means the total amount of magnesium stearate and calcium carbonate.

TABLE 1

| | | | | | | Partial | | Amount of | | |
|---|---|---|---|---|---|---|---|---|---|---|
| | | Content of | | | | compression | | residual | | |
| | | fluidity | Average | Partial | Apparent | loading/ | Number | styrene | | |
| | | accelerator | particle | compression | specific | apparent specific | of | type | Unusual- | |
| | Type of fluidity | (parts by | diameter | loading | density | density | bubbles | monomers | sound | Feel |
| | accelerator | weight) | (μm) | (N) | (g/mm³) | (Nmm³/g) | (bubble/mm) | (ppm) | test | test |
| Example 1 | Zinc stearate | 0.59 | 830 | 0.094 | 0.033 | 2.85 | 28 | 95 | ◯ | ⊚ |
| Example 2 | Zinc stearate | 0.75 | 830 | 0.083 | 0.033 | 2.52 | 27 | 90 | ◯ | ⊚ |
| Example 3 | Zinc stearate | 1.20 | 830 | 0.080 | 0.033 | 2.42 | 30 | 98 | ◯ | ⊚ |
| Comparative | Zinc stearate | 0.30 | 830 | 0.111 | 0.033 | 3.36 | 29 | 102 | X | ◯ |
| Example 1 | | | | | | | | | | |
| Example 4 | Magnesium stearate | 0.51 | 830 | 0.093 | 0.033 | 2.82 | 28 | 88 | ◯ | ⊚ |
| Example 5 | Calcium carbonate | 0.52 | 840 | 0.091 | 0.032 | 2.84 | 27 | 95 | ◯ | ⊚ |
| Example 6 | Zinc stearate | 0.45 | 830 | 0.098 | 0.033 | 2.97 | 47 | 96 | ◯ | ⊚ |
| Example 7 | Zinc stearate | 0.74 | 820 | 0.075 | 0.034 | 2.21 | 72 | 92 | ◯ | ⊚ |
| Comparative | Zinc stearate | 0.59 | 1800 | 0.204 | 0.033 | 6.18 | 23 | 100 | X | X |
| Example 2 | | | | | | | | | | |
| Example 8 | Zinc stearate | 0.59 | 750 | 0.145 | 0.049 | 2.96 | 33 | 95 | ◯ | ◯ |
| Example 9 | Magnesium | 0.52 | 710 | 0.121 | 0.050 | 2.42 | 75 | 121 | ◯ | ⊚ |
| | stearate + | | | | | | | | | |
| | calcium carbonate | | | | | | | | | |

As can be seen from Examples 1 to 3 and Comparative Example 1, the expanded resin beads containing the fluidity accelerator in the range of 0.4 to 1.5 parts by weight endow the cushioning body with excellent properties.

Even if different fluidity accelerators are used, their effect is almost the same, as can be seen from Examples 1 to 9.

As can be seen from Example 1 and Comparative Example 2, a cushioning body excellent in properties can be obtained insofar as the average particle diameter of the expanded resin beads is in the range of 400 to 900 μm.

### EFFECT OF THE INVENTION

According to the first and second cushioning bodies of the present invention, expanded resin beads having a very small particle diameter in the range of 400 to 900 μm are used as fillers and these beads are made flowable i.e. easily sliding mutually by very small strength thereby achieving significant improvements in the touch and feel. The cushioning bodies using these beads do not generate an unusual sound giving an unpleasant feel.

The expanded resin beads each having 25 to 80 bubbles/mm in the direction of diameter when cut along a face containing the diameter of the expanded resin particle can be used to provide a cushioning body hardly generating an unusual sound.

Further, the styrene-based resin having an apparent specific gravity of 0.01 to 0.2 can be used to maintain the strength of the expanded resin beads and to prevent the weight of the cushioning body from being unnecessarily high.

Furthermore, the expanded resin beads wherein the amount of residual styrene type monomers is 500 ppm or less or the amount of volatile organic compounds is 1000 ppm or less can be used to provide a cushioning body which can be utilized more comfortably even by a very few persons very sensitive to styrene type monomers or volatile organic compounds.

In addition, when the bag is constituted of a stretchable material, the following effects are demonstrated. First, the expanded resin beads have the effect described above, that is, the expanded resin beads have easily fluidizing and sliding properties upon application of very small strength, thus providing the cushioning body with significant improvement in the touch and feel. A stretching material is uses for the bag so that when a part of the cushioning body is compressed, the packed beads can move from the compressed region to the rest of the bag, whereupon the rest of the bag can be stretched and deformed to accommodate the moving beads, thus broadening the allowable range of movement of the beads. In addition, the cushioning body having a better feel can be provided due to the synergistic effect of the expanded resin beads and the bag.

For example, when the surface of the bag is printed with a face having eyes, nose, and mouth etc., the face can given expressions by the properties of the expanded resin beads and the bag (called an animation effect).

Further, in the case of the cushioning body ridden or hold by a person, the above synergistic effect gives suitable stimuli to the skin of the person, which would generate much alpha wave in the brain. As a result, the bag can be expected to provide a cushioning body making the person more easily relaxing.

By providing the bag with a double fastener capable of opening and closing, the bag can effectively prevent leakage of the fillers therefrom.

The expanded resin beads filling in the first and second cushioning bodies can be used to provide the first and second cushioning bodies having the excellent characteristics described above.

1. A cushioning body comprising a large number of expanded resin beads used as fillers into a bag, wherein the expanded resin beads have an average particle diameter of 400 to 900 μm and a value of 3 Nmm³/g or less obtained by dividing a partial compression loading by an apparent specific gravity.

2. A cushioning body comprising a large number of expanded resin beads used as fillers together with a fluidity accelerator into a bag, wherein the expanded resin beads have an average particle diameter of 400 to 900 μm and the content of the fluidity accelerator is 0.4 to 1.5 parts by weight based on 100 parts by weight of the expanded resin beads.

3. A cushioning body according to claim 1, wherein the expanded resin beads each have 25 to 80 bubbles/mm (unit length) in the direction of diameter when cut along a face containing the diameter of the expanded resin particle.

4. A cushioning body according to claim 1, wherein the expanded resin beads comprise styrene-based resin having an apparent specific gravity of 0.01 to 0.2.

5. A cushioning body according to claim 1, wherein the expanded resin beads comprise styrene-based resin and the amount of residual styrene type monomers contained in the styrene-based resin is 500 ppm or less.

6. A cushioning body according to claim 1, wherein the amount of volatile organic compounds contained in the expanded resin beads is 1,000 ppm or less.

7. A cushioning body according to claim 1, wherein the bag is constituted of a stretchable material.

8. A cushioning body according to claim 1, wherein the bag is provided with a double fastener capable of opening and closing.

9. Expanded resin beads for filling a cushioning body having an average particle diameter of 400 to 900 μm and a value of 3 Nmm³/g or less obtained by dividing a partial compression loading by an apparent specific gravity.

10. Expanded resin beads for filling a cushioning body comprising expanded resin beads having an average particle diameter of 400 to 900 μm and a fluidity accelerator, the content of the fluidity accelerator being 0.4 to 1.5 parts by weight based on 100 parts by weight of the expanded resin beads.

11. Expanded resin beads for filling a cushioning body according to claim 9, wherein the expanded resin beads each have 25 to 80 bubbles/mm (unit length) in the direction of diameter when cut along a face containing the diameter of the expanded resin particle.

12. Expanded resin beads for filling a cushioning body according to claim 9, wherein the expanded resin beads comprise styrene-based resin having an apparent specific gravity of 0.01 to 0.2.

13. Expanded resin beads for filling a cushioning body according to claim 9, wherein the expanded resin beads comprise styrene-based resin and the amount of residual styrene type monomers contained in the styrene-based resin is 500 ppm or less.

14. Expanded resin beads for filling a cushioning body according to claim 9, wherein the amount of volatile organic compounds contained in the expanded resin beads is 1,000 ppm or less.

15. A cushioning body according to claim 2, wherein the expanded resin beads each have 25 to 80 bubbles/mm (unit length) in the direction of diameter when cut along a face containing the diameter of the expanded resin particle.

16. A cushioning body according to claim 2, wherein the expanded resin beads comprise styrene-based resin having an apparent specific gravity of 0.01 to 0.2.

17. A cushioning body according to claim 2, wherein the expanded resin beads comprise styrene-based resin and the amount of residual styrene type monomers contained in the styrene-based resin is 500 ppm or less.

18. A cushioning body according to claim 2, wherein the amount of volatile organic compounds contained in the expanded resin beads is 1,000 ppm or less.

19. A cushioning body according to claim 2, wherein the bag is constituted of a stretchable material.

20. A cushioning body according to claim 2, wherein the bag is provided with a double fastener capable of opening and closing.

21. Expanded resin beads for filling a cushioning body according to claim 10, wherein the expanded resin beads each have 25 to 80 bubbles/mm (unit length) in the direction of diameter when cut along a face containing the diameter of the expanded resin particle.

22. Expanded resin beads for filling a cushioning body according to claim 10, wherein the expanded resin beads comprise styrene-based resin having an apparent specific gravity of 0.01 to 0.2.

23. Expanded resin beads for filling a cushioning body according to claim 10, wherein the expanded resin beads comprise styrene-based resin and the amount of residual styrene type monomers contained in the styrene-based resin is 500 ppm or less.

24. Expanded resin beads for filling a cushioning body according to claim 10, wherein the amount of volatile organic compounds contained in the expanded resin beads is 1,000 ppm or less.
